(19) United States
(12) Patent Application Publication
(10) Pub. No.: US 2017/0013822 A1
(43) Pub. Date: Jan. 19, 2017

(54) AGRICULTURAL VEHICLE WITH BOOM LATCH ASSEMBLY

(71) Applicants: Curt Sporrer, Clarion, IA (US); Jared Smith, Goldfield, IA (US)

(72) Inventors: Curt Sporrer, Clarion, IA (US); Jared Smith, Goldfield, IA (US)

(21) Appl. No.: 14/797,239

(22) Filed: Jul. 13, 2015

(51) Int. Cl. A01M 7/00; A01G 25/09

(52) U.S. Cl. CPC A01M 7/0075; A01G 25/09

(57) ABSTRACT

A system and method for latching a boom of a vehicle. A boom with a plurality of wings is provided. The wings are hinged together and a linear actuator is provided to extend and fold the wings. When the wings are extended, a latching assembly secures the boom in the extended position. A retainer on one of the wings receives a catch on another of the wings. A pin then extends through the catch to retain the catch and maintain the boom in the extended position. When it is desired to fold the boom, the pin is retracted and the linear actuator folds the wings.

### TECHNICAL FIELD

The disclosed embodiments relate in general to an agricultural vehicle with a boom having foldable wing sections and, more specifically, to an agricultural vehicle with foldable wing sections that can be automatically latched into place.

### BACKGROUND OF THE INVENTION

Agricultural spray booms are known in the art. Such vehicles include a tank with material to be applied to an agricultural field and a spray boom to apply the material to the field. It is desirable to have a very wide spray boom to reduce the number of passes needed to treat a particular field. It is also desirable to minimize the width of the sprayer for transport and storage. Spray booms associated with such vehicles are typically provided in sections hinged to one another and designed to allow the boom to fold into a transport position or be partially folded to work around obstacles in fields or non-uniform field boundaries.

A common layout in the industry is to provide a boom with a center section, or a main wing, a pair of mid wings, and a pair of breakaways at each end of the boom. The provision of hinged foldable wing sections allows for a very wide boom that may be folded for transport and storage. However, with very wide booms, when the vehicle stops or starts, a dynamic load or force is applied across the boom and through the hinges and hydraulic actuators coupling the sections to one another. The components most susceptible to damage associated with such motion are the hydraulic actuators and joints between the main wing and the mid wing sections. Given the larger forces on these components, they are typically the first failure point of the boom. To overcome this problem, it is known in the art to make these components larger. One drawback associated with such larger components is that they increase the mass of the boom. Another drawback is that they move the center of gravity of the boom further from the midpoint of the machine, thereby creating larger forces on the boom during motion, due to increased inertia.

It is also known in the art to address the damage to the joints between the main wing and mid wings by making the main wing as long as possible, thereby reducing the moment about the main wing to mid wing joints. One drawback associated with making the main wing longer is that this increases the minimum width of the boom for transport and storage.

It would therefore be desirable to provide a vehicle with a boom having a narrow light weight main wing, low overall weight, a center of gravity nearer the mid point of the boom, and reduced stress on the joints and hydraulic cylinders provided between the main wing and mid wings. The difficulties discussed herein above are sought to be eliminated by the present invention.

### SUMMARY OF THE DISCLOSED SUBJECT MATTER

The present invention includes systems and methods for latching sections of a spray boom to one another. An agricultural vehicle is provided with a frame and a boom coupled to the frame. The boom has a main wing coupled to a folding wing by a hinge. A boom latching assembly is provided between the main wing and folding wing to prevent the folding wing from folding relative to the main wing. The boom latching assembly has a retainer and a catch releasably engaged to the retainer. A linear actuator is coupled to the boom latching assembly to latch and unlatch the folding wing relative to the main wing.

The features and advantages described in this summary and the following detailed description are not all inclusive. Many additional features and advantages may be apparent to one of ordinary skill of the art in view of the drawings specification and claims presented herein.

### BRIEF DESCRIPTION OF THE DRAWINGS

FIG. 1 illustrates a front elevation of the vehicle shown with the boom in the extended and locked position;

FIG. 2 illustrates a side elevation of the vehicle of FIG. 1;

FIG. 3 illustrates a front perspective view of a portion of the boom shown in FIG. 1;

FIG. 4 illustrates a side elevation of the vehicle shown with the boom in the folded position;

FIG. 5 illustrates a front perspective view of the latching assembly of FIG. 1 shown in the extended and locked position;

FIG. 6 illustrates a front perspective view of the latching assembly of FIG. 1 shown in the extended and locked position;

FIG. 7 illustrates a front elevation and partial cutaway of the latching assembly of FIG. 1 shown latching the boom sections into the locked position;

FIG. 8 illustrates a schematic of the hydraulically actuated boom latching assembly of the present invention.

### DETAILED DESCRIPTION OF THE DRAWINGS

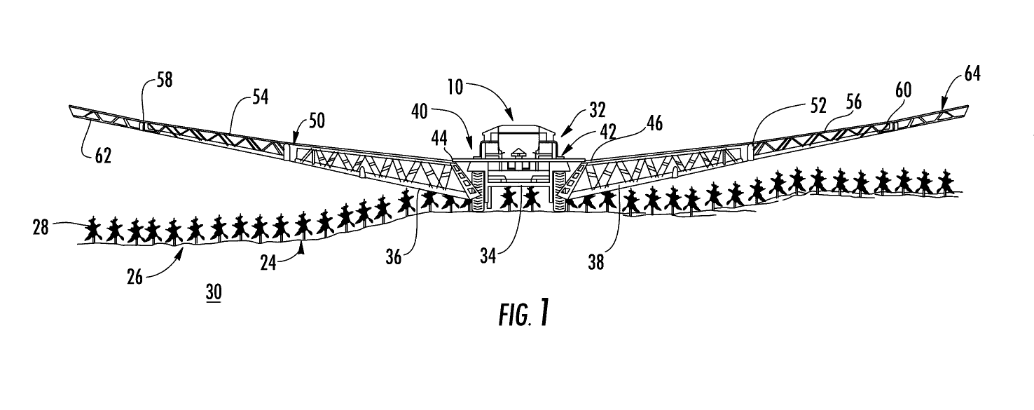

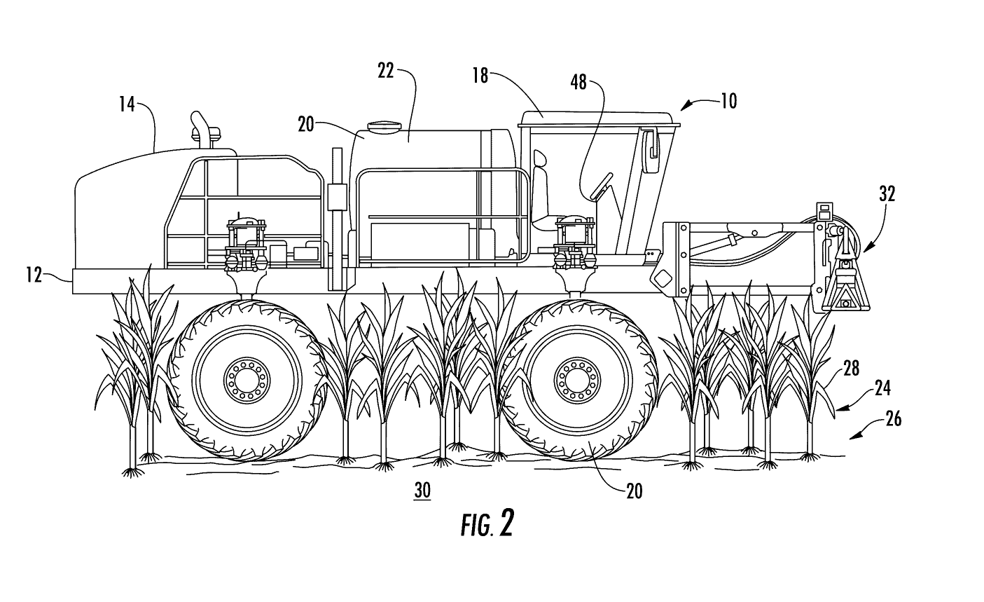

As shown in FIGS. 1, 2, and 4, a high clearance wheeled agricultural vehicle (10) is provided with a frame (12). Coupled to the frame (12) are an engine (14) a hydraulic pump (16) and an operator station (18). While the vehicle (10) may be of any type known in the art, in the preferred embodiment the vehicle (10) is a Hagie STS 12 sprayer provided with a 1200 gallon tank (20) for storing fluid (22) to be applied to crops (24) weeds (26) pests (28) and/or the soil (30).

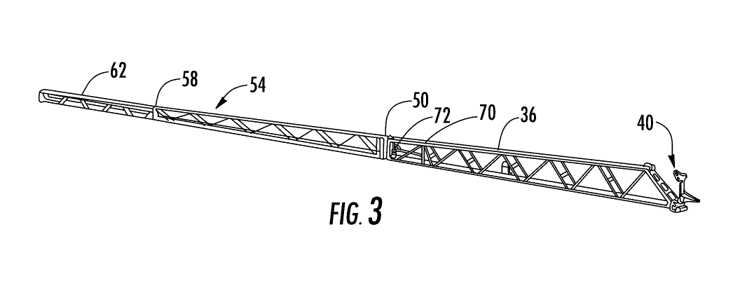

Releasably secured to the vehicle (10) is a boom (32) which, in the preferred embodiment, is a spray boom. As shown in FIGS. 1 and 3, the boom (32) is provided with a central main boom (34) coupled to a first main wing (36) and second main wing (38) by a pair of hinge assemblies (40 & 42) coupled between the central main boom (34) and main wing (36) is a linear actuator such as a hydraulic cylinder (44). Similarly, coupled between the central main boom (34) and main wing (38) is another linear actuator such as a hydraulic cylinder (46). The hydraulic cylinders (44 & 46) are hydraulically coupled to the hydraulic pump (16) and are actuated by an electronic control panel (48) located in the operator's station (18) in a manner such as that known in the art. Also as shown in FIGS. 1-3, coupled to the main wings (36 & 38) by a pair of hinge assemblies (50 & 52) are a pair of folding wings (54 & 56). While the hinge assemblies (50 & 52) may be of any suitable construction and location, in the preferred embodiment, the hinge assemblies (50 & 52) are located on the rearward portions of the main wings (36 & 38) and folding wings (54 & 56). Similarly, coupled to the folding wings (54 & 56) by a pair of hinge assemblies (58 & 60) are a pair of breakaway wings (62 & 64). While the construction may be of any suitable type known in the art, in the preferred embodiment, the main wings (36 & 38) fold rearward relative to the vehicle (10), the folding wings (54 & 56) fold forward relative to the main wings (36 & 38). It should be obvious to one of ordinary skill in the art that any suitable size, construction, and folding structure known in the art may be used for the boom (32).

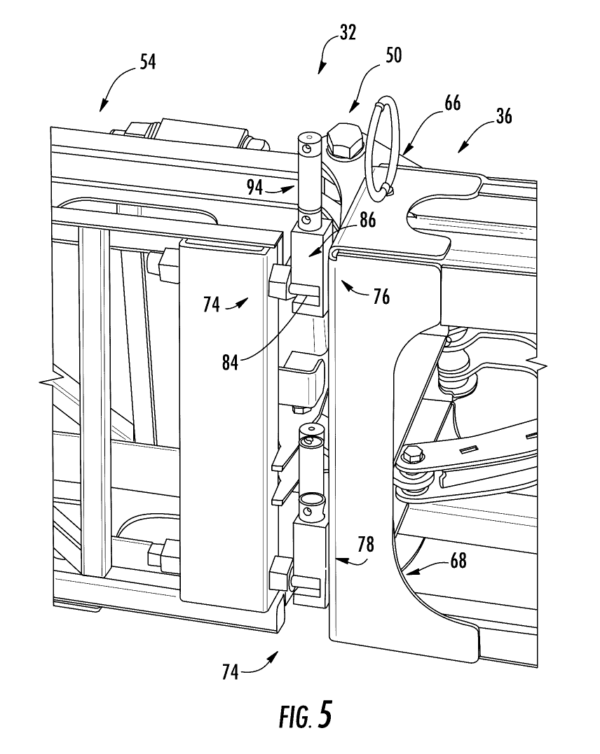

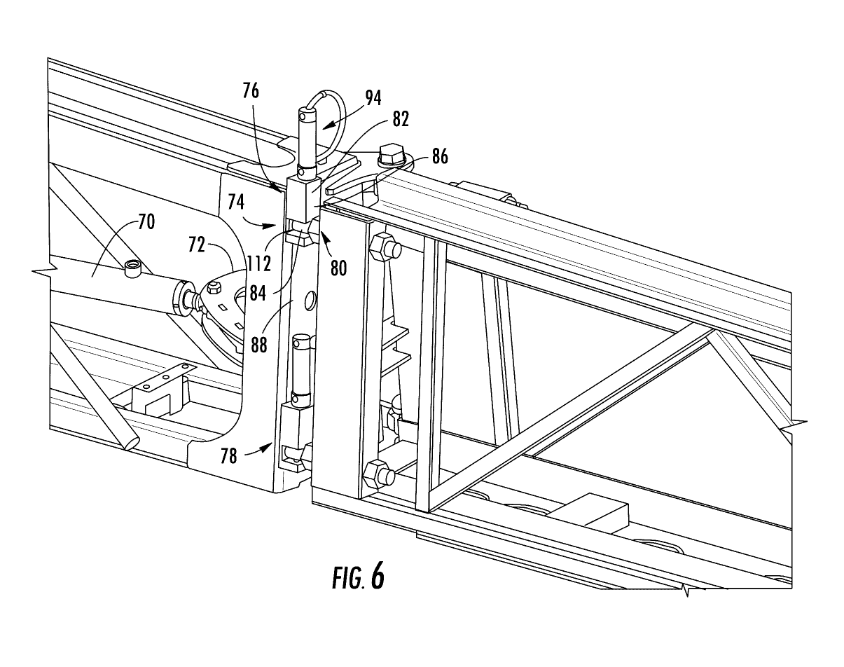

As the pairs of main wings (36 & 38), folding wings (54 & 56), and breakaways (62 & 64) are mirror images of one another, description will be limited to the main wing (36), folding wing (54), and breakaway (62). As shown in FIG. 5, the main wing (36) is coupled to the folding wing (54) by the hinge assembly (50). As shown in FIGS. 5 and 6, the hinge assembly (50) includes a top hinge (66) coupled to the tops of the main wing (36) and folding wing (54) and a bottom hinge (68) coupled to the bottoms of the main wing (36) and folding wing (54). A boom pivot actuator such as a hydraulic cylinder (70) is pivotably coupled on one end to the main wing (36) and pivotably coupled on the other end to a steel yoke (72). The yoke (72), in turn, is pivotably coupled on one end to the main wing (36) and pivotably coupled on the other end to the rear of the folding wing (54). The yoke is configured and coupled to the folding wing (54) in such a manner that when the hydraulic cylinder (70) retracts, the yoke (72) pivots against the main wing (36), thereby drawing the opposite arm of the yoke (72) and pulling the folding wing (54) into extension and alignment with the main wing (36). Conversely, when the hydraulic cylinder (70) is extended, the yoke (72) pivots against the main wing (36) causing the opposite arm of the yoke (72) to push against the folding wing (54) and pivot the folding wing (54) into the folded or cradled position for transport, storage, etc.

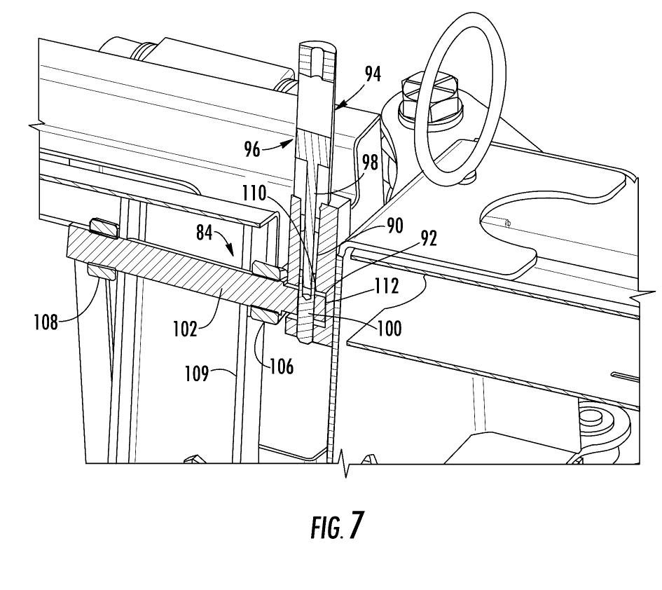

As shown in FIGS. 5-7 a boom latching assembly is coupled to the main wing (36) and folding wing (54). The boom latching assembly (74) includes an upper assembly (76) and a lower assembly (78). As the two assemblies (76 & 78) are substantially identical, description will be limited to the upper assembly (76), with the understanding that the lower assembly (78) is similarly constructed albeit positioned below the upper assembly (76). The upper assembly (76) is provided with a retainer (80) a receiver (82) and a catch (84). The receiver (82) is preferably a rectangular steel block (86) welded to the outward face (88) of the main wing (36). The steel block (86) as shown in FIG. 7 is provided with a central throughbore (90) passing from the top of the retainer (80) through the bottom of the retainer (80). The receiver (82) is also provided with a rectangular cutout (92) to receive the catch (84). The central thoughbore (90) is preferably threaded at the top to threadably receive a boom latching assembly such as a hydraulic cylinder (94). As shown in FIG. 7, the barrel (96) of the hydraulic cylinder (94) is located above the receiver (82) while the piston (98) of the hydraulic cylinder (94) extends into the central througbore (90). While in the preferred embodiment, a catch (84), such as a small steel shot pin (100), is secured to the bottom of the piston (98), if desired, the piston (98) may be used as the catch (84) in the boom latching assembly (74). Preferably the hydraulic cylinder (94) is provided with a 1.00 inch bore and a 1.81 inch stroke. The steel shot pin (100) is 0.5 inches in diameter, 2.13 inches long, and tapped on one end to thread into a female thread in the piston (98) of the hydraulic cylinder (94).

As shown in FIG. 7, the catch (84) has a lockrod (102) provided through a steel bracing assembly (104) in the folding wing (54). The lockrod (102) is preferably 1.0 inch in diameter, 8.0 inches long, and threaded on each end. Nuts (106 & 108) are threaded onto each end of the lockrod (102) to secure the lockrod (102) to the steel bracing assembly (104). One end of the lockrod (102) is provided with a slot (110) having a diameter slightly larger than that of the steel shot pin (100). The nuts (106 & 108) may be turned to adjust the lockrod (102) so that the end (112) of the lockrod (102) having the slot (110) fits into the receiver (82) so that the slot (110) aligns with the steel shot pin (100) when the folding wing (54) and main wing (36) are extended and aligned. Once the folding wing (54) and main wing (36) are extended and aligned, the hydraulic cylinder (94) is actuated to drive the steel shot pin (100) into the slot (110) of the lockrod (102), thereby securing the folding wing (54) to the main wing (36) on the opposite side from the hinge assembly (50). The lower assembly (78) operates in a similar manner to secure the folding wing (54) to the main wing (36) on the opposite side from the hinge assembly (50). Without the latching assembly (74), the forward and rearward movement of the vehicle (10) would cause high loads to be delivered through the hydraulic cylinder (70), requiring a larger hydraulic cylinder (70), a more expensive construction of the hydraulic cylinder and/or more frequent maintenance and replacement. The boom latching assembly (74) takes the forward and rearward load in tension, thereby reducing stress on the hydraulic cylinder (70) and distributing the forces more evenly across the folding wing (54) and the main wing (36).

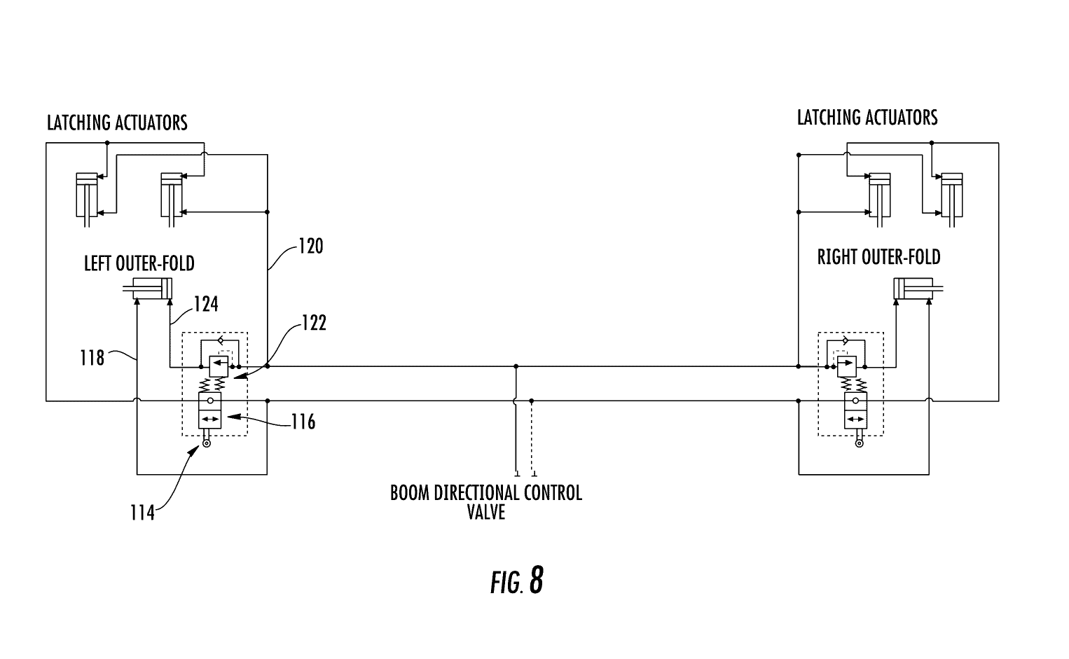

As shown in the schematic in FIG. 8 and in FIGS. 1, 2 and 7, when it is desired to extend the folding wing (54) relative to the main wing (36) the control panel (48) is used to direct hydraulic fluid from the hydraulic pump (16) to the hydraulic cylinder (70), retracting the hydraulic cylinder (70) and causing the yoke (72) to pivot and swing the folding wing (54) around the hinge assembly (50) into alignment with the main wing (36). Once the folding wing (54) comes into alignment with the main wing (36), the lock rod (102) comes into contact with the steel block (86) thereby stopping further rotation of the folding wing (54) relative to the main wing (36). This swinging action also causes a portion of the folding wing (54) to activate a cam-operated valve (114) located on the main wing (36). As shown in the schematic in FIG. 8, once the cam-operated valve (114) is activated, the flow of hydraulic fluid is diverted to the locking hydraulic cylinder (94), pushing the steel shot pin (100) through the slot (110) in the lock rod (102) positioned within the rectangular cutout (92) of the steel block (86). If desired, the cam-operated valve (114) may be located on the folding wing (54) and actuated when a portion of the main wing (36) contacts the cam-operated valve (114) once the folding wing (54) has fully extended relative to the main wing (36). Additionally, the hydraulic cylinder (70) is provided with position sensors that provide feedback to the control panel (48) to indicate that the folding wing (54) is fully extended relative to the main wing (36). Accordingly, these position sensors may be used in lieu of or in conjunction with the cam-operated valve (114) to redirect hydraulic fluid from the boom latching assembly (74) to the hydraulic cylinder (70) and vice versa.

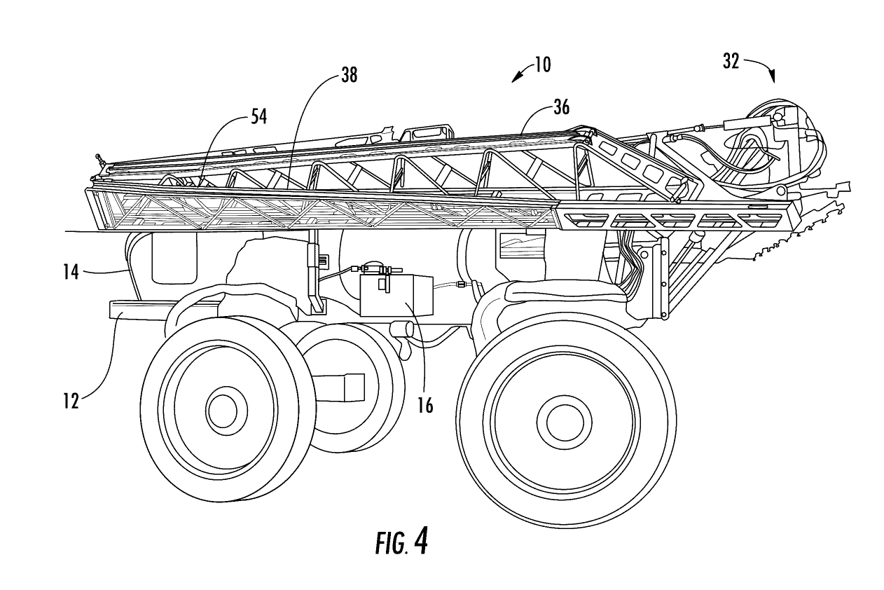

When it is desired to retract the folding wing (54) from the main wing (36) for transport or storage, the mechanical cam-operated valve (114) is reversed causing hydraulic fluid to pass through the hydraulic line (120) into the hydraulic cylinder (94) thereby retracting the piston (98) and steel shot pin (100) from the slot (110) of the lock rod (102). Once the hydraulic cylinder (94) has fully retracted the steel shot pin (100) causing the hydraulic cylinder (94) to dead head, thereby increasing the system pressure and overcoming a pressure relief valve (122). This allows hydraulic fluid to pass through the hydraulic line (124) to extend the hydraulic cylinder (70) thereby causing the folding wing (54) to swing around the hinge assembly (50) and main wing (36) toward the cradled position shown in FIG. 4.

Although the invention has been described with respect to a preferred embodiment thereof, it is to be understood that it is not to be so limited since changes and modifications can be made therein which are within the full, intended scope of this invention as defined by the appended claims. For example any number of latching assemblies, such as the upper assembly (76) and lower assembly (78), may be used. The boom latching assembly (74) may also be coupled between the folding wing (54) and main wing (36) in any desired manner, orientation or location. While the retainer (80) is shown located on the main wing (36) and catch (84) located on the folding wing (54), the retainer (80) may instead be coupled to the folding wing (54) and the catch (80) coupled to the main wing (36). In yet another alternative embodiment of the present invention, a mechanical linkage system or pneumatic system may be substituted in place of the hydraulic system to actuate the boom latching assembly (74) of the present invention in a manner such as that known in the art. Still another embodiment of the present invention may include alternative types of boom latching assemblies, such as a hook and latch, or any other mechanical, electronic, hydraulic, or pneumatic latch systems known in the art.

What is claimed is:

1. An agricultural vehicle, comprising:
(a) a frame;
(b) a boom coupled to the frame, the boom comprising:
(i) a main wing;
(ii) a folding wing pivotably coupled to the main wing;
(iii) a hinge coupled between the main wing and the folding wing;
(c) a boom latching assembly coupled to the main wing and the folding wing, configured to prevent the folding wing from folding, the boom latch assembly comprising;
(i) a retainer;
(ii) a catch releasably engaged to the retainer; and
(d) a boom latching assembly actuator, coupled to the boom latching assembly.

2. The vehicle of claim 1, wherein the boom latching assembly further comprises:
(a) a supplemental retainer; and
(b) a supplemental catch releasably engaged to the supplemental retainer.

3. The vehicle of claim 2, wherein the folding wing comprises a top and a bottom, and wherein the catch is located closer to the top of the folding wing than to the supplemental catch, and wherein the supplemental catch is located closer to bottom of the folding wing than to the catch.

4. The vehicle of claim 2, wherein the catch and the supplemental catch are located on the folding wing and wherein the retainer and supplemental retainer are located on the main wing.

5. The vehicle of claim 1, wherein the retainer is a retractable pin.

6. The vehicle of claim 5, wherein the catch defines a slot, and wherein the retractable pin is located at least partially within the slot.

7. The vehicle of claim 5, wherein the boom latching assembly actuator comprises a linear actuator.

8. The vehicle of claim 1, wherein the hinge is located substantially on the opposite side of the main wing and the folding wing from the boom latching assembly.

9. An agricultural vehicle, comprising:
(a) a frame;
(b) a boom coupled to the frame, the boom comprising:
(i) a first wing;
(ii) a second wing pivotably coupled to the first wing;
(iii) a hinge coupled between the first side of the first wing and the first side of the second wing;
(iv) wherein the boom is extensible from a folded position to an extended position;
(c) a boom latching assembly coupled to the first wing and the second wing and configured to prevent the second wing from folding into the folded position, the boom latch assembly comprising;
(i) a first retainer coupled to the second wing,
(ii) a first catch coupled to the first wing and configured to releasably receive the first retainer;
when the boom is in the extended position;
(iii) a second retainer;
(iv) a second catch configured to releasably receive the second retainer when the boom is in the extended position; and
(d) wherein when the boom latching assembly is configured to prevent the boom from folding when the first retainer is received in the first catch.

10. The vehicle of claim 9, wherein first retainer is a retractable pin.

11. The vehicle of claim 10, wherein the first catch defines a slot, and wherein the retractable pin is located at least partially within the slot.

13. The vehicle of claim 10, further comprising a linear actuator coupled to the retractable pin.

14. The vehicle of claim 10, wherein the first catch comprises a slotted rod configured to receive the retractable pin.

15. The vehicle of claim 9, further comprising a linear actuator configured to extend the boom from the folded position to the extended position.

16. The vehicle of claim 9, wherein the first retainer comprises a receiver configured to receive the first catch.

17. A boom latch assembly comprising:
(a) a boom comprising:
(i) a first wing;
(ii) wherein the first wing has a top, a bottom, a first side and a second side;
(iii) a second wing pivotably coupled to the first wing;
(iv) wherein the second wing has a top, a bottom, a first side and a second side;
(v) a hinge coupled to the first side of the first wing and the first side of the second wing;
(vi) a linear actuator configured to extend the boom from a folded position to an extended position;
(b) a latching assembly coupled to the first wing and the second wing and configured to prevent the second wing from folding into the folded position, the boom latch assembly comprising;
(i) a catch coupled to the first wing;
(ii) a retainer coupled to the second wing, the retainer comprising;
a. a receiver configured to receive the catch when the boom is in the extended position;
b. a pin configured to releasably engage the catch when the boom is in the extended position;
c. a linear actuator coupled to the pin and configured to move the pin in and out of engagement with the catch; and
(c) wherein when the latching assembly is configured to prevent the boom from folding when the first retainer is received in the first catch.

18. The boom latch assembly of claim 17, wherein the catch defines a slot, and wherein the pin is located at least partially within the slot.

19. The boom latch assembly of claim 17, further comprising a supplemental latching assembly coupled to the first wing and the second wing and configured to prevent the second wing from folding into the folded position.

20. The boom latch assembly of claim 19, wherein when the boom is in the extended position, the latching assembly and supplemental latching assembly are located between the first wing and the second wing.
